(19) United States
(12) Patent Application Publication
(10) Pub. No.: US 2007/0133438 A1
(43) Pub. Date: Jun. 14, 2007

(54) Method and system for reserving resources in a conferencing system

(75) Inventors: Shmuel Shaffer, Palo Alto, CA (US); Labhesh Patel, San Francisco, CA (US); Steven L. Christenson, Campbell, CA (US)

Correspondence Address: BAKER BOTTS L.L.P., 2001 ROSS AVENUE, SUITE 600, DALLAS, TX, 75201-2980, US

(73) Assignee: Cisco Technology, Inc.

(21) Appl. No.: 11/305,522

(22) Filed: Dec. 14, 2005

(51) Int. Cl. H04L 12/16

(52) U.S. Cl. 370/260

(57) ABSTRACT

A method for reserving resources in a conferencing system includes receiving a conference reservation request for a first conference comprising at least one invitee. The method also includes reserving for the at least one invitee a conference resource to allow the at least one invitee to participate in the first conference using the conference resource. The conference resource is usable by the at least one invitee to participate in one or more additional conferences occurring simultaneously with the first conference.

### TECHNICAL FIELD OF THE INVENTION

This invention relates generally to communications systems and more particularly to methods and systems for reserving resources in a conferencing system.

### BACKGROUND

Historically, telecommunications have involved the transmission of voice and fax signals over a network dedicated to telecommunications, such as the Public Switch Exchange (PBX). Similarly, data communications between computers have been historically transmitted on a dedicated data network, such as a Local Area Network (LAN) or a Wide Area Network (WAN). Currently telecommunications and data transmissions are being merged into an integrated communication network using technology such as Voice over Internet Protocol (VoIP). Because many LANs and WANs transmit computer data using Internet Protocol (IP), VoIP uses this existing technology to transmit voice and fax signals by converting these signals into digital data and encapsulating the data for transmission over an IP network.

Traditional communication networks often support multipoint conferences between a number of participants using different communication devices. A multipoint control unit (MCU) (sometimes referred to as a multipoint conference unit) is used to couple these devices, which allows users from distributed geographic locations to participate in the conference. The conference may be audio only (e.g. a teleconference) or it may include video conferencing/broadcasting.

Conference systems utilize various resources when hosting a conference. One of the key resources that conference administrators may need to indicate when setting up a conference call is the number of ports required for the conference. Reservation of the “correct” number of conferencing ports can be a balancing act. If too few ports are reserved for the conference, some people who would like to join and contribute may be left out because there may not be enough resources to accommodate them. However, if too many ports are reserved then some ports may remain unused. This increases the cost of conducting a conference and potentially prevents other users from conducting a conference at the same time.

Numerous algorithms and systems have been developed to facilitate more flexible reservation of resources for conferences. For example, some systems include methods for reserving network bandwidth that would be required for conducting a VoIP conference. Some systems include methods for reclaiming and recycling conference resources of users who leave a given conference. In addition, some systems include methods for finding and booking conference rooms (and/or other fixed resources). For example, users may have knowledge of available local conference resources, and scheduling systems may consult the location information of the scheduler (and/or invited participants) to match with the nearest available conference resource(s).

### SUMMARY

The present invention provides methods and systems for reserving resources in a conferencing system that substantially eliminate or reduce disadvantages and problems associated with previous systems and methods.

In accordance with a particular embodiment of the present invention, a method for reserving resources in a conferencing system includes receiving a conference reservation request for a first conference comprising at least one invitee. The method includes reserving for the at least one invitee a conference resource to allow the at least one invitee to participate in the first conference using the conference resource, the conference resource usable by the at least one invitee to participate in one or more additional conferences occurring simultaneously with the first conference.

The method may also include sending a conference invitation for the first conference to the at least one invitee and receiving from the at least one invitee an invitation response indicating an intention to participate in the first conference.

The method may also include connecting the at least one invitee to the first conference using the reserved conference resource to enable the at least one invitee to participate in the first conference. The method may include receiving a request from the at least one invitee to participate in a second conference of the one or more additional conferences. The method may also include transferring the at least one invitee from the first conference to the second conference using the reserved conference resource to enable the at least one invitee to participate in the second conference. The second conference may include a conference to which the at least one invitee did not receive an electronic conference invitation.

The method may also include receiving from the at least one invitee a reservation request indicating an intention to participate in a second conference occurring simultaneously with the first conference. The method may include, in response to receiving the indication from the at least one invitee, reserving for the at least one invitee a second conference resource to allow the at least one invitee to participate in the second conference using the second conference resource while the at least one invitee participates in the first conference using the first conference resource.

In accordance with another embodiment of the present invention, a method for reserving resources in a conferencing system includes reserving for a participant, for a participatory amount of time, a conference resource usable by the participant to participate in any one of a plurality of conferences. The method also includes connecting the participant to a first conference of the plurality of conferences using the reserved conference resource to enable the participant to participate in the first conference and then receiving within the participatory amount of time a request from the participant to participate in a second conference of the plurality of conferences. The method also includes transferring the participant from the first conference to the second conference using the reserved conference resource to enable the participant to participate in the second conference.

In accordance with another embodiment of the present invention, a system for reserving resources in a conferencing system includes an interface operable to receive a conference reservation request for a first conference comprising at least one invitee. The system includes a processor operable to reserve for the at least one invitee a conference resource to allow the at least one invitee to participate in the first conference using the conference resource, the conference resource usable by the at least one invitee to participate in one or more additional conferences occurring simultaneously with the first conference.

The system may also include a processor that is further operable to connect the at least one invitee to the first conference using the reserved conference resource to enable the at least one invitee to participate in the first conference. The interface may be further operable to receive a request from the at least one invitee to participate in a second conference of the one or more additional conferences. The processor may be further operable to transfer the at least one invitee from the first conference to the second conference using the reserved conference resource to enable the at least one invitee to participate in the second conference.

Technical advantages of particular embodiments of the present invention include methods and systems that enable a user to have conference resources specifically reserved for him. In some embodiments the resources are reserved for the user for the duration of a particular conference. In some embodiments the resources are reserved for the user for a pre-determined amount of time, unrelated to any conferences that may be scheduled. Accordingly, the user, for whom resources have been reserved, can effectively join a conference without having to compete for resources. Another technical advantage of particular embodiments of the present invention is that users can use the same conference resource that was reserved for them to switch between various different conferences, without having to compete for general conference resources. Another technical advantage of particular embodiments of the present invention is that conferencing systems can conserve resources by not reserving multiple conference resources when the user may only plan on using one conference resource at a time. Accordingly, the resources of the conferencing system are conserved, thus allowing more participants to attend a conference and allowing the conference system to host more conferences, without having to increase the amount of resources the conference system has in its general pool of resources.

Other technical advantages will be readily apparent to one skilled in the art from the following figures, descriptions and claims. Moreover, while specific advantages have been enumerated above, various embodiments may include all, some or none of the enumerated advantages.

### BRIEF DESCRIPTION OF THE DRAWINGS

To provide a more complete understanding of the present invention and the features and advantages thereof, reference is made to the following description, taken in conjunction with the accompanying drawings, in which:

FIG. 1 illustrates a communication system including a plurality of endpoints operable to communicate among each other and a conferencing system, in accordance with a particular embodiment of the present invention;

FIG. 2 illustrates a conferencing system in more detail, illustrating aspects of an embodiment of the present invention; and

FIG. 3 illustrates a method for reserving resources in a conferencing system, in accordance with an embodiment of the present invention.

### DESCRIPTION OF EXAMPLE EMBODIMENTS

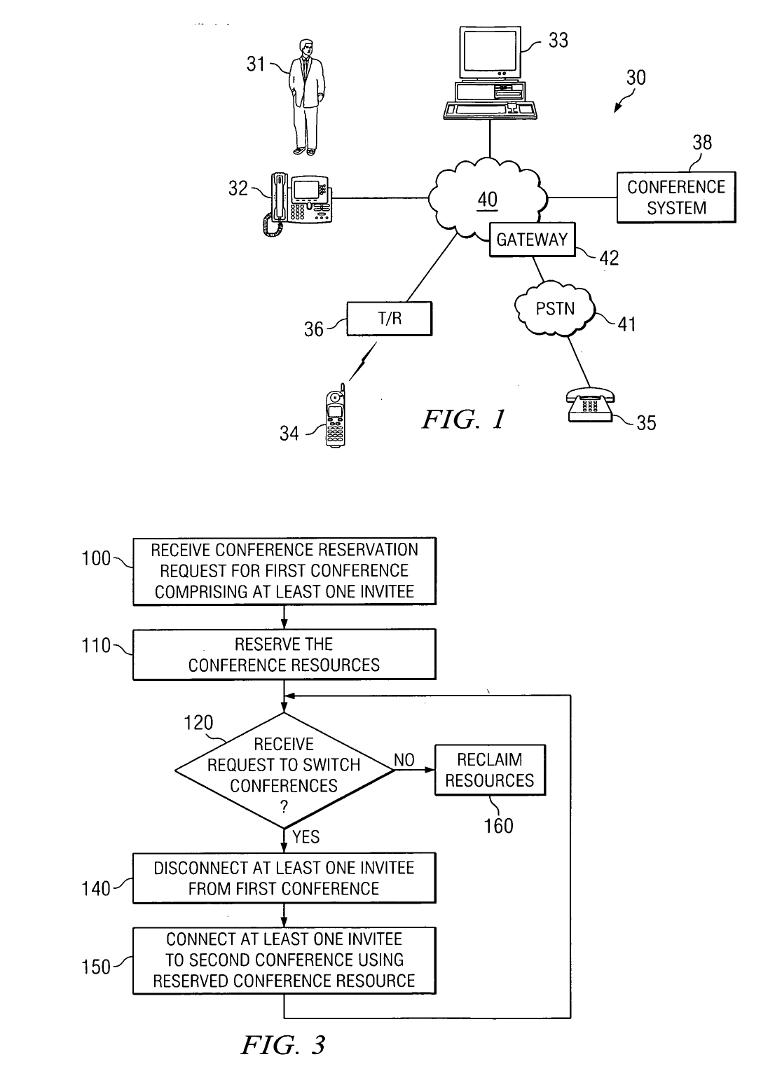

FIG. 1 illustrates a communication system 30 including a plurality of endpoints 32-35 having the ability to establish communication sessions with each other and/or a conference system 38. Such communication sessions may be established using communication networks 40, 41 and/or additional endpoints, components or resources coupled with communication networks 40 or 41. Conference system 38 provides multipoint conference services, including conference hosting and/or facilitation, to users of endpoints 32-35, such as user 31 of endpoint 32. In particular embodiments, conference system 38 may comprise a multipoint control unit (MCU) (sometimes referred to as multipoint conference unit) that hosts, or accommodates, multipoint conferences between and among endpoints 32-35. An MCU or other entity may be considered to be hosting a conference if it is one or more of the components that accommodates or otherwise provides conference resources to facilitate the conference.

Conferences may include communication sessions between a plurality of users transmitted using any audio and/or video means, including signals, data or messages transmitted through voice and/or video devices, text chat, web sessions, and instant messaging.

In accordance with particular embodiments, systems and methods are provided that allow a conference system to reserve resources for individual users as opposed to individual conferences. For example, resources may be allocated or assigned for use by individual users. Because the resources are reserved for the individual user, it is possible for the conference system to reduce the number of resources that are reserved for a particular conference by reducing the number of resources reserved for the conference by the number of required invitees that have resources already reserved for them.

An overlap between resource reservations can occur when the same user plans on attending multiple conferences with at least some overlap in their respective scheduled times, in other words when at least one conference starts before all the other conferences have ended. The overlap is a result of both conferences having reserved sufficient resources to ensure that the same user could attend each conference. The ability to reduce overlapping resource reservations to individual users relies on the fact that a single user, in most situations, will likely participate in only one conference at a time. This is because, while the two conferences may be occurring simultaneously, the user may only listen and talk to one person or group at a time and so may switch between the conferences in a serial fashion, using the resource specifically reserved for him.

The user to whom a resource is reserved has the ability to use that resource to not only attend any conferences he was invited to but to attend any other conferences that may be occurring simultaneously. Conferences may occur simultaneously when there is at least some overlap in the occurrence of conferences. For example, a conference ending at 4:00 may be deemed to be occurring simultaneously with another conference that begins at 3:59, because the two conferences overlap by a minute. The user may go to these other simultaneous conferences even if he has not been invited to them, and even if their start time and end time do not match the start time and end time of the conference for which he has resources reserved. In some embodiments, the conference system may reserve a resource for a particular individual when the individual has been invited to attend a particular conference. In some embodiments the resource may be reserved for the individual for a particular amount of time to allow the individual to participate in any conference taking place during that particular amount of time. In the former case, the resource can be reserved for the individual for the entire scheduled duration of the conference to which he was invited.

Endpoints 32-35 may be any combination of hardware, software and/or encoded logic that provide communication services to a user. For example, endpoints 32-35 may include a telephone, a mobile phone, a computer running telephony software, a video monitor, a camera or any other communication hardware, software and/or encoded logic that supports the communication of media using communication networks 40 and 41. In the illustrated embodiment endpoints 32-34, coupled to communication network 40, include an internet protocol (IP) phone, a personal computer and a cellular phone, respectively. Endpoint 35 is a telephone that is coupled to communication network 41. A wireless base station transmitter/receiver (T/R) 36 couples endpoint 34 with communication network 40. Endpoints 32-35 may also include unattended or automated systems, gateways, other intermediate components or other devices that can establish media sessions. Although FIG. 1 illustrates four endpoints 32-35, communication system 30 contemplates any number and arrangement of endpoints 32-35 for communicating media and participating in a conference. For example, the described technologies and techniques for establishing a communication session between or among endpoints 32-35 may be operable to establish a multipoint conference between more than two endpoints 32-35.

Although specific communication networks 40 and 41 are illustrated in FIG. 1, the term “communication network” should be interpreted as generically defining any network capable of transmitting audio and/or video telecommunications signals, data and/or messages. Communication network 40 may be any computer or communication network capable of coupling two or more endpoints 32-35, for communication. In the illustrated embodiment, communication network 40 is a wide area network (WAN) that enables communication between a plurality of endpoints distributed across multiple cities and geographic regions, and communication network 41 is a public switched telephone network (PSTN). However, communication networks 40 and/or 41 may comprise one or more networks, including the Internet, the public switched telephone network, local area networks (LANs), global distributed networks such as intranets and extranets and/or other forms of wireless or wireline communication networks. Generally, communication networks 40 and 41 provide for the communication of packets, cells, frames and/or other portions of information (generally referred to as packets) between and among endpoints 32-35. Communication paths for the communication of such packets may include any combination of routers, hubs, switches, gateways (e.g., gateway 42) or other hardware, software or embedded logic implementing any number of communication protocols that allow for the exchange of packets in communication system 30.

In a particular embodiment, communication network 40 employs communication protocols that allow for the addressing or identification of endpoints 32-35 coupled to communication network 40. For example, using Internet protocol, each of the components coupled together by communication network 40 in communication system 30 may be identified in information directed using IP addresses. In this manner, communication network 40 may support any form and combination of point-to-point, multicast, unicast or other techniques for exchanging media packets among components in communication system 30.

Any given communication session between two of endpoints 32-35 may include the transfer of packets across one or more communication paths that couple endpoints 32-35 and/or conference system 38 across communication networks 40 and 41. Such paths may include any combination of network components, gatekeepers, call managers, routers, hubs, switches, gateways, endpoints or other hardware, software or embedded logic implementing any number of communication protocols that allow for the exchange of packets in communication system 30.

Network 40 may be directly coupled to other IP networks including, but not limited to, the Internet. Since IP networks share a common method of transmitting data, telecommunication signals may be transmitted between telephony devices located on different, but interconnected, IP networks. In addition to being coupled to other IP networks, network 40 may also be coupled to non-IP telecommunication networks through the use of appropriate hardware, such as gateway 42. For example, network 40 is coupled to Public Switched Telephone Network (PSTN) 41. PSTN 41 includes switching stations, central offices, mobile telephone switching offices, pager switching offices, remote terminals and other related telecommunications equipment that are located across the country.

IP networks transmit data (including voice and video data) by placing the data in packets and sending each packet individually to the selected destination. Unlike a circuit-switched network (like PSTN 41), dedicated bandwidth is not required for the duration of a call or fax transmission over IP networks. Instead, each telephony device sends packets across the network as they become available for transmission. This feature makes bandwidth available for other data when voice or fax data is not being transmitted.

The technology that allows telecommunications to be transmitted over an IP network may be referred to as Voice over IP (VoIP). In the illustrated embodiment, endpoints 32-34 and conference system 38 are IP telephony devices. IP telephony devices have the capability of encapsulating a user's voice (or other inputs) into IP packets so that the voice can be transmitted over network 40. Similarly, IP telephony devices 32-34 have the capability of capturing and encapsulating video into IP packets so that the video can be transmitted over network 40. Conversely, IP telephony devices 32-34 have the capability of receiving audio or video IP packets from the network 40 and playing the audio or video data to a user.

A codec (coder/decoder) at the endpoint converts the voice, video or fax signals generated by the users of the telephony devices from analog media signals into digital form. The codec may be implemented either in software or as special-purpose hardware in the endpoints. In the case of IP telephone 32, as user 31 speaks into the handset, the codec converts the analog voice signals into digital data. The digitally encoded data is then encapsulated into IP packets so that it can be transmitted over network 40. Conversely, another codec at the receiving endpoint converts the digital data into analog media for the users of the telephony devices. In the case of an IP telephone, digital data from IP encapsulated packets are received from the network 40. The codec at the receiving endpoint converts the digital voice, video or other data from the network 40 into analog media to be played to the users of the telephony devices.

Gateway 42 may accomplish several functions, such as converting analog or digital circuit-switched data transmitted by PSTN 41 to packetized data transmitted by network 40 and vice-versa. When voice data packets are transmitted from network 40, gateway 42 retrieves the data contained in the incoming packets and converts this digital data to the analog or digital format used by the PSTN trunk to which gateway 42 is coupled. Since the digital format for voice transmissions over an IP network is often different than the format used on the digital trunks of PSTN 41, the gateway provides conversion between these different digital formats, which is referred to as transcoding. Gateway 42 also translates between the VoIP call control system (e.g., MGCP, H.323, SIP, etc.) and other signaling protocols (e.g., SS7, T1, ISDN, etc.), used in PSTN 41.

For voice transmissions from PSTN 41 to network 40, the process is reversed. In a particular embodiment, gateway 42 takes the incoming voice transmission (in either analog or digital form) and converts it into the digital format used by network 40. The digital data is then encapsulated into IP packets and transmitted over network 40.

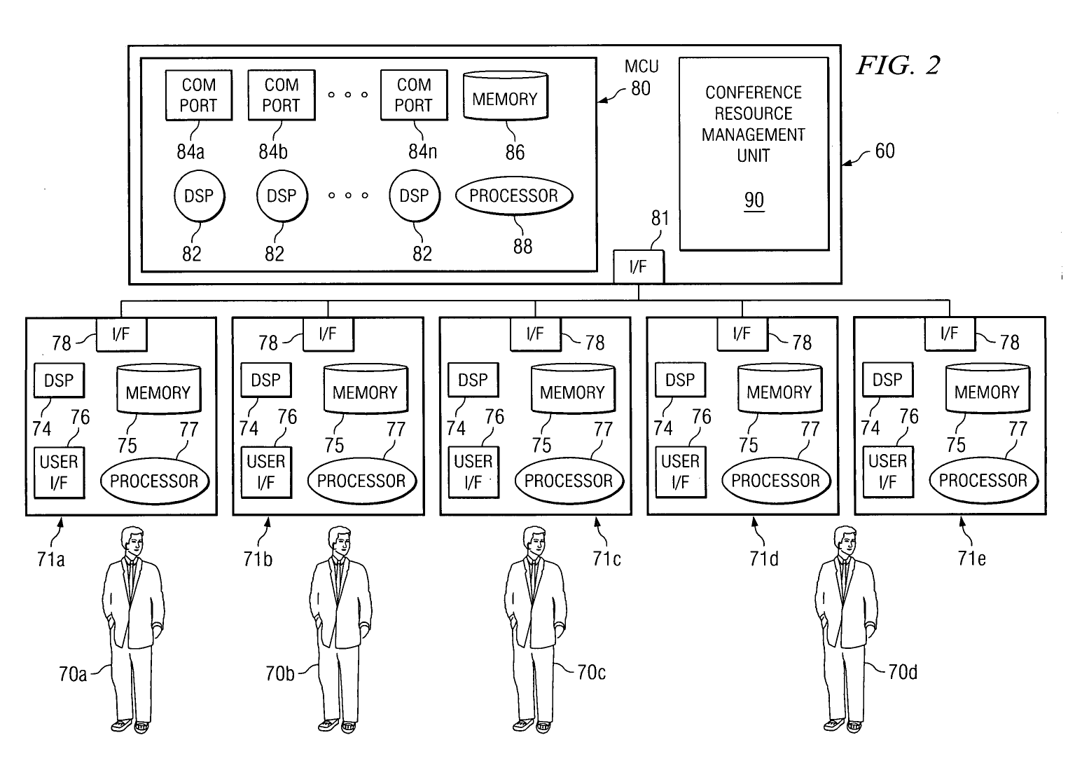

FIG. 2 illustrates a conference system 60 in more detail, in accordance with a particular embodiment of the present invention. Conference system 60 may be similar to conference system 38 illustrated in FIG. 1. Conference system 60 is coupled to a plurality of endpoints 71, in accordance with a particular embodiment. Conference system 60 provides conference services, including conference hosting and/or facilitation, to users of endpoints 71 and may provide similar functionality as that provided by conference system 38 discussed above. In the illustrated embodiment, conference system 60 includes an MCU 80, a conference resource management unit 90 and an interface 81 through which conference system 60 is coupled to the network (e.g., network 40 of FIG. 1) and over which it receives calls for conference. MCU 80 provides multipoint conference functionality between participants/users 70a-70d using endpoints 71a-71e. Conference resource management unit 90 manages resources of conference system 60, such as conference ports, bandwidth and DSP resources.

Endpoints 71a-71e may be similar to one or more of the endpoints described above with respect to FIG. 1, such as IP phone endpoint 32. It should be understood that endpoints 71a-71e may be coupled to components of conference system 60 such as MCU 80 and conference resource management unit 90 through one or more communication networks, such as communication networks 40 and 41 described above with respect to FIG. 1 which may include one or more WANs or LANs as indicated above. Although not shown in FIG. 2, it should be understood that conference system 60 and endpoints 71 are all coupled to each other via one or more of the networks such as networks 40 or 41 of FIG. 1.

In the illustrated embodiment, endpoints 71a-71e each include a digital signal processor (DSP) 74, memory 75, user interface 76, processor 77 and interface 78. Endpoints 71 are coupled to conference system 60 through interfaces 78. DSP 74 includes a codec that converts voice, video or IM signals generated by the users of the telephony devices from analog media signals into digital form and vice-versa. The codec may be implemented either in software or as special-purpose hardware in the endpoints.

Memory 75 may include any form of volatile or nonvolatile memory including, without limitation, magnetic media, optical media, random access memory (RAM), read only memory (ROM), removable media or any other suitable local or remote memory component. Memory 75 may store information about the endpoint and/or its user(s). Processor 77 may comprise one or more microprocessors, controllers or any other suitable computing devices or resources.

User interface 76 may include a microphone, video camera, speaker, keyboard, video display, LCD display and/or other device. In some embodiments, an endpoint's user interface 76 may be coupled with components that include a microphone, video camera, speaker, keyboard, video display and/or other device, rather than incorporating such components into the endpoint.

MCU 80 acts as an intermediary during the multipoint communication conference, collects audio and/or video streams transmitted by the participants through their endpoints and distributes such streams to participants of the multipoint conference at their endpoints. MCU 80 may include any bridging or switching device used in support of multipoint conferencing, including videoconferencing. In various embodiments, MCU 80 may include hardware, software and/or embedded logic. MCU 80 may be configured to support any number of conference endpoints communicating on any number of conferences, simultaneously. MCU 80 may be in the form of customer provided equipment (CPE, e.g., beyond the network interface) or may be embedded in a wide area network (WAN). Examples of multipoint conference unit standards are defined in ITU-T H.323, with T.120 describing services for real-time, multipoint data connections and conferencing. MCU 80 utilizes certain resources to effectively host each conference.

In the illustrated embodiment, MCU 80 includes a plurality of digital signal processors (DSPs) 82, a plurality of communication ports 84a-84n, a processor 88 and memory 86. DSPs 82 include codecs that decode received media streams so that they may be bridged together to form a mixed stream that is coded by the DSPs for transmission to conference participants. In particular embodiments, MCU 80 may include software functioning as a DSP on a general purpose central processing unit, such as processor 88. Communication ports 84 may comprise audio, video, and/or other data communication ports.

Memory 86 may be any form of volatile or nonvolatile memory including, without limitation, magnetic media, optical media, random access memory (RAM), read only memory (ROM), removable media or any other suitable local or remote memory component. Processor 88 may be a microprocessor, controller or any other suitable computing device or resource.

Conference resource management unit 90 may comprise any suitable hardware, software or encoded logic to accomplish the functionality described herein, such as a processor or controller executing software. The conference resources managed by conference resource management unit 90 may include any hardware or software component utilized by an MCU for hosting a conference between participants. Conference resources may include, for example, bandwidth, audio and video communication ports or trunks and DSP resources for transcoding or mixing. Resources available to MCUs may be utilized across any number of conferences occurring simultaneously and between any number of endpoints. For example, if an MCU has a certain number of communication ports available for conference use, one conference may utilize some of the communication ports, and another conference occurring simultaneously may utilize the rest of the communication ports. In particular embodiments, some of the MCU's communication ports may be reserved for individual participants, for example users 70a-70d, (instead of to specific conferences) for use at any of a number of conferences that may be occurring simultaneously. In some cases, when a conference participant leaves a conference the communication ports and other resources utilized by that conference participant may be made available to other participants of that conference or to other conferences. Thus, the conference participant that leaves a conference may not be able to immediately rejoin the conference because the resource he was using initially was given to someone else, and so now to rejoin the conference he has to wait for another resource to free up.

As indicated above, in particular embodiments conference resources may be reserved for individual users to use at one of any of a plurality of conferences occurring simultaneously. As an example of particular embodiments in operation, consider the following scenario where user 70d uses endpoint 71d, to enter information into conference system 60 to establish a conference with other users. After entering, for example, the appropriate start time and date, as well as the expected duration, and possibly the topic, user 70d determines that he expects ten people to attend his conference. Of these ten expected attendees, user 70d wants to make sure that users 70a and 70b are able to attend. When user 70d sets up the conference he sends a request to conference system 60 indicating that users 70a and 70b are to be required invitees. Accordingly, user 70d has designated users 70a and 70b as required invitees. Conference system 60 reserves resources for required invitees. The required invitee designation guarantees them access to this conference as well as any other conferences occurring simultaneously, because the resources are reserved and attached specifically to them. Therefore, the resources they use when joining any conference are those resources that have been reserved for them. They may not need to use any of the resources from a pool of resources for which the other attendees may be competing.

In this example, user 70d has sent a request for a conference to which she expects there to be 10 attendees, of which three (user 70a, 70b and 70d) are required invitees. When conference system 60 is setting up the scheduled conference it will reserve seven sets of resources for the conference, and one set of resources for each of users 70a, 70b and 70d (assuming they do not already have resources reserved for them, as discussed in more detail below). The resources reserved for users 70a, 70b and 70d are separately attached to each one of them, for example, from the scheduled start time of the conference to the scheduled end time of the conference. Additionally, because the resources are reserved for the individual user, the individual user can not only use those resources to attend the conference to which she is a required invitee, but also to attend a conference to which she is not a required invitee, even if a pool of resources reserved for that conference are already being used by other attendees of the conference. That is because as user 70a joins the conference she uses the set of resources that were reserved for her, and so does not require any of the pool of resources reserved for the conference. For example, if a resource, such as a conference port, has been reserved for user 70a, user 70a may use the conference port to attend any of the number of conferences occurring simultaneously with the conference for which the resource was reserved for her. It should be understood that in particular embodiments the user may only use the port that was reserved for her to attend one conference, of the plurality of conferences occurring simultaneously, at a given time, as the user would need to utilize more than one conference port to attend more that one conference at the same time. As indicated above, the user may, however, use the reserved conference port to serially switch between a plurality of conferences occurring simultaneously for as long as she has the conference port reserved. The user can switch as often as she may want without affecting the resources of any of the conferences into or out of which she is switching.

As indicated above, conference system 60 not only reserves resources generally for a conference, but also reserves resources for specific users 70. This, in effect, guarantees a user, for example user 70a, who has resources reserved for her, such as a conference port, access to a conference, regardless of the number of actual attendees compared to the number of scheduled attendees.

The invitation of users 70a and 70b to attend user 70d's conference can be transparent to users 70a and 70b (the conference system 60 does not notify them that they have been invited to a conference) or it can be visible in a variety of ways. For example, the conference system 60 can be integrated with scheduling software, such as Microsoft Outlook, so that when user 70d schedules the conference users 70a and 70b receive notifications of the conference in Outlook. Regardless of whether or not users 70a and 70b are sent notifications alerting them of their invitations, conference system 60 can be set up so that they never have to accept an invitation to actually have the resources reserved for them; rather the resources can be automatically reserved for them as soon as the conference is set up. Additionally, if user 70a, for example, has been invited to multiple conferences occurring simultaneously, user 70a does not have to specify which conference(s) she plans to attend because whatever resources are reserved for her for one conference are associated with her and are usable by her to attend any other conference occurring simultaneously with the conference for which her resources were originally reserved.

If the conference system 60 is set up so that notices of invitations are sent, the notifications can be completely passive in that they merely inform users 70a and 70b that they have been invited to a conference, or they can be active in that they require a response from users 70a and 70b. Some examples of responses that conference system 60 may attempt to elicit include, but are not limited to: whether the user will need additional resources, perhaps for some multi-media capabilities; if the user has been invited to multiple conferences, whether he wants extra resources to be reserved for him; if the user has been invited to multiple conferences, how many additional resources he needs.

The prompting for a response from the user is especially useful when the user plans on attending multiple conferences at the same time. The reservation of one set of resources should be sufficient to cover most users' needs since a user typically will only be able to effectively listen to one speaker at a time and speak to one set of users at a time. Thus to participate in multiple simultaneous conferences the user may switch back and forth between the conferences. In other words, the user may participate in multiple conferences in a serial fashion as opposed to a parallel fashion. However, if the user needs to be able to participate in multiple conferences at the same time, then he may be able to elect to have multiple sets of resources reserved for him. This may be the case for a user with multiple endpoints, such as user 70d who can access endpoints 71d and 71e, and he may want to use both endpoints at the same time. It should be noted that where no response is elicited or where the system is not provisioned to allow for the reservation of multiple sets of resources, the user who wishes to participate in multiple conferences, at the same time (in a parallel fashion), can still do so, he will just have to compete for the additional resources just as other attendees have to compete for resources.

Once conference system 60 receives the request for a conference it may reserve available resources were appropriate. Conference system 60 may use some combination of conference resource management unit 90, processor 88 and/or memory 86 to check to see if any resources have already been reserved for any of the required invitees. If they have not had any other resources reserved for them then conference system 60 may reserve and record the appropriate amount of conference resources to them. If, on the other hand, a user has already had resources reserved for him, for example the user is a required invitee for another conference, conference system 60 can adjust the current reservation to eliminate any unwanted overlap between the current reservation and the previous reservation.

Continuing with the scenario begun above in which users 70a and 70b were required invitees and user 70d was the user who set up the conference with ten expected attendees, conference system 60 may reserve a set of resources, for example communication ports 84a-84g and DSPs 82, to cover the seven attendees ([10 expected attendees]−[3 required invitees]) that were not required invitees. For the seven resources reserved for the conference generally, attendees will have to compete for these seven generally reserved sets of resources to be able to join the conference. If more users want to attend the conference than there are resources reserved for the conference then, after the available reserved resources have been used, the additional user may be placed in a queue, which may be maintained within conference resource management unit 90, to await the availability of resources. In some embodiments conference system 60 may increase the number of general resources originally reserved for the conference to accommodate the additional users who wish to attend. The number of additional resources that may be reserved for the conference may depend on how rigid the scheduling protocol of the conference system 60 has been configured and on the number of resources not already reserved for other conferences or invitees, during the entire scheduled duration of the current conference.

Building on the scenario introduced and continued above, at some point either during or after user 70d set up her conference, user 70c, using his IP phone, sets up a second conference that is to start at the same time as the conference user 70d set up, but which is scheduled to end some time after the conference user 70d set up is scheduled to end. User 70c schedules the conference to have ten expected attendees, with user 70a being someone whom he wants to be sure will be able to attend. The conference system 60 reserves resources for this second conference, for both the second conference in general and the required invitees, users 70a and 70c, using the same process as it did when scheduling the first conference.

While conference system 60 may go through the same procedure, the result may be different now because user 70a has been invited to two conferences that occur simultaneously. Rather than reserve two sets of resources, one set of resources per conference, for user 70a, conference system 60 determines the earliest start time and the latest end time that user 70a needs resources reserved for him. Conference system 60 then reserves one set of resources for user 70a that begins at the earliest start time and ends at the latest end time. This avoids having multiple resources reserved for a single user, who may only need one set of resources.

Having only one set of resources reserved for user 70a may not prevent him from attending both conferences because he can use the single set of resources that have been reserved for him to freely transfer between multiple conferences. He may transfer out of one conference, then after a period of time, still within the time period for which he has resources reserved, he can transfer into another conference. This means that he does not always have to be using his resource to keep the reservation, and that he does not have to immediately be connected to a second conference after being disconnected from a first conference. He can even join other conferences to which he is not a required invitee by using the same resources that were reserved for him. In particular embodiments user 70a is able to freely switch between conferences, even those conferences that may have attendees waiting in queues, because he uses the resources that have been reserved for him to join conferences. Thus he does not use or need any of the resources that have been reserved for the conference in general. So if user 70c attempts to join user 70d's conference, for example after it has started and all seven attendee spots have been filled, he does not have to wait for resources to free up because he can join the conference using the resources that have been reserved for him as a required invitee. This is true even though user 70c was not even invited to user 70d's conference.

It is worth noting, that because user 70a can send specific invitations to those users for whom he wants to guarantee a spot at the conference he can schedule the conference for fewer attendees because he does not have to worry about making sure that there are enough resources for everyone who might want to participate, plus those that he needs to participate. Along that same line, a system manager in charge of conference system 60 may configure conference system 60 to more aggressively limit the amount of resources reserved for conferences above and beyond the amount originally reserved for the conference. Additionally, in some embodiments the conference system 60 may reserve resources in a way that allows for conferences having more scheduled attendees than there are resources generally available. For example a conference system having five conference resources generally available can schedule two conferences with each conference having three attendees each where one of the attendees is a required invitee of both conferences. This is possible because the conference system 60 can recognize that there is a common required invitee and that the required invitee will only use one resource to attend the two conferences. Thus, to conduct the two conferences having six attendees the conference system only needs to reserve five resources.

Conference system 60 also allows for conference resources to be reserved for individual users for a participatory amount of time. This provides a system manager with greater flexibility in how resources are reserved by allowing her to balance user accessibility against system efficiency. For example, it may be decided that user 70a needs to be able to have access to any conference at any time. Thus he may have a set of conference resources permanently reserved for him, or reserved for him for a specific period of time independent of any conferences. From the user accessibility point of view, this is advantageous for user 70a in that he never has to worry about competing for resources or not being able to join a conference. On the other hand, from the system efficiency point of view, this could be inefficient because it may not be that user 70a is actually going to be involved in every conference. So the resources reserved for him may spend time being reserved, but unused. To help compensate for this, in particular embodiments conference system 60 allows for a required invitee or a user who has permanently reserved resources to be able to temporarily assign the reservation of resources to a different user.

As an additional feature some embodiments of conference system 60 provide a system administrator with a report detailing various statistics about the conference system and how the users are using it. One of the possible statistics the conference system may monitor is how many times a particular user has requested multiple sets of resources and how many times he fully used the resources he requested.

It will be recognized by those of ordinary skill in the art that conference system 60 is merely one example configuration of a conference system for reserving resources in a conferencing system, in accordance with an embodiment of the present invention. Other conference systems may include any number of interfaces, MCUs, processors, memory modules, DSPs, communication ports, management units and/or other components to accomplish the functionality and features described herein. For example, although conference system 60 is illustrated and described as including interface 81, processor 88, conference resource management unit 90, memory module 86, MCU 80, communication ports 84, and DSPs 82, these components and other desired components for performing the above described functionality may be centrally located (local) with respect to one another, or distributed throughout communication system 60.

FIG. 3 is a flowchart illustrating a method for reserving resources in a conferencing system, in accordance with an embodiment of the present invention. The method begins at step 100 where a conference reservation request is received. The request to set up the conference may include information such as a list of invitees, a list of required invitees, the number of expected attendees, the date, the start time and the duration. Additional information such as the subject or purpose of the conference could also be entered at this time.

At step 110 conference resources are reserved. Reserved conference resources may include, for example, conference ports and/or DSP resources. The list of required invitees received at step 100 is checked against a database or list containing information about all the invitees for all the conferences that this conference system is moderating. In performing the check, the conference system attempts to locate any previous invitations, to any of the required invitees on the list received at step 100, which may overlap in time with the current invitation. This step also contemplates attempting to locate any reservation of resources that may have been extended to users either indefinitely or for a predetermined amount of time.

Based on the results of the check described above and how the system has been configured, the system reserves the necessary resources for the conference currently being scheduled at step 100. In one embodiment the conference system starts by reserving a set of resources for each required invitee for the entire duration of the conference. Resources reserved for specific users (as opposed to particular conferences) may be usable by the users to participate in other conferences. If the conference system is set up to default to reserving only one resource per user, the original resource reservation is reduced by any overlap that was discovered during the check described above. For example, if user A is a required invitee for conference 1 which is scheduled from 1:30 to 3:30 (and has had a resource reserved for that time) and is also a required invitee for conference 2 from 2:00 to 5:00, then the conference system, when reserving resources for conference 2, may not reserve resources for user A from 2:00 to 5:00. Rather, the conference system would simply extend the time period that the conference 1 resources were reserved for user A; that is, the resources initially reserved for conference 1 would be extended from 1:30-3:30 to 1:30-5:00 to accommodate conference 2. If overlapping resources were not eliminated, then user A would have one set of resources from 1:30 to 3:30 and a second set of resources from 2:00 to 5:00, thus creating overlap from 2:00 to 3:30. Similarly, if the user is a required invitee for conference 1 and is invited to conference 2 as an attendee, then when the conference system reserves resources for conference 2 it recognizes that resources have already been reserved for the user from 1:30 to 3:30 and so can reduce the number of resources that are reserved for the conference in general.

In another embodiment, the required invitee is provided with options for overriding the reservation of resources made by the conference system. This option could be exercised when an invitee responds to his invitation. For example, in the scenario above, if user A wants two sets of resources for the time of overlap, 2:00 to 3:30, then in his response to the invitation he could specify that he does not want the conference system to reserve only one set of resources for him. In some embodiments, he could tell the conference system how many resources he actually wants. In some embodiments, the system can be set up so that the user initially has one resource reserved for him for each invitation, regardless of the amount of overlap. In this situation the conference system would prompt the user to determine if he would like to release the overlapping resources.

In some embodiments the prompt can be relatively simple, for example having the user check a box for adding additional resources or releasing overlapping resources, as the case may be. In other embodiments, the prompt can be more involved where the user can actually enter in the amount and duration of additional resources he needs, or overlapping resources he wants to release.

Regardless of the embodiment, once the actual number of resources that are to be reserved for a required invitee is determined, those resources are reserved specifically for that required invitee. This reservation attaches the resources to the required invitee so that as the required invitee transfers between conferences he uses the same set of resources.

The number of expected attendees received at step 100 may include both the number of required invitees and general attendees. The number of general attendees (expected attendees minus required invitees) is used in determining the number of resources to reserve initially for the conference. The actual number of resources used by the conference may fluctuate as system resources and configurations allow. For example, the system may be configured to initially reserve for the conference enough resources to facilitate the participation of the general attendees, but then allow additional attendees to join the conference if the conference system has resources available in the general pool of resources that have not already been reserved for another conference or required invitee. Alternatively, the number of expected attendees can be an upper limit to the number of attendees, and the conference system may not reserve additional resources for the conference, even if resources are available.

The system reserves resources for the conference in general based on the number of general attendees. The number of general attendees is determined by taking the number of expected attendees and subtracting the number of required invitees. As mentioned above, the amount of system resources reserved for general attendees can be as rigid or as flexible as desired. For example suppose user X is setting up a conference and she wants users A and B to participate as well as anyone else who may be interested but whose presence may not be critical. If resources are reserved only for the conference then she may be inclined to select a very large number of expected attendees that is much greater than the number of attendees she actually expects to attend because she wants to be sure that there are enough resources available to accommodate users A and B should they join the conference late. If user X instead, designates users A and B as required invitees, then she can reduce her number of expected attendees because she is already assured that A and B can attend because they have been invited, and so have had resources reserved specifically for them. Even if users A and B want to join a conference in which there are more general attendees that want to attend than there are resources that were initially reserved for the conference, users A and B should have no problem joining the conference. It is the general attendees that may have more difficulty in attending the conference. The degree of their difficulty may depend on how the conference system is set up. The more rigid the scheduling protocol is the less flexibility the conference system has in adding additional resources, from the general pool of resources, to the resources already reserved for a conference.

Once the conference resources have been reserved for the required invitees and the conference in general, the conference system, at step 120, determines whether it has received a request from a required invitee to transfer or switch conferences. If no request comes the system continues to wait for the expiration of the time that the resources were reserved for the required invitee. If on the other hand the system receives a request to switch conferences then the system will transfer the required invitee by disconnecting, at step 140, the required invitee from the first conference and then, at step 150, connecting him to a second conference using the same resource that he was using in the first conference. The time between disconnecting the user at step 140 and connecting the user at step 150, can be as long or as short as the user may desire.

When the required invitee is connected to the first conference he is connected using the same conference resource that was reserved for him, and which he used to participate in the first conference. This means that as he joins or leaves a conference he should not affect the general resources reserved for the conference. Thus, when the required invitee is disconnected from the first conference and connected to the second conference, his doing so should not impact the resources being used by either conference. This is because the only resource that is involved in his joining both conferences is the resource that was reserved for him, not one of the resources that were reserved for the conference in general.

Once the required invitee has been connected to the second conference the conference system returns to step 120 to determine whether it has received a request to from a required invitee to transfer or switch conferences. The required invitee can switch between as many conferences and as many times as he wants, so long as the resources reserved for him have not expired or otherwise been reclaimed.

Once the time that the resource was reserved for the required invitee has expired the conference system can reclaim that resource at step 160. Depending on how the conference system has been provisioned the conference system can reclaim the resource at a number of different times. In some embodiments it reclaims the resource as soon as the allotted time has passed, in which case the required invitee would become a general attendee and would have to compete for resources just like everyone else to remain in the conference. In some embodiments, after the allotted time has passed, the system reclaims the resource after the invitee leaves whatever conference he is presently participating in when the allotted time runs out. In other words, he gets to hold onto the resources reserved for him after it has expired so that his participation in the current conference is not interrupted, but as soon as he leaves that conference he loses the resource that was reserved for him. Some embodiments may reclaim the resource as soon as the invitee is no longer participating in any conference, even if the allotted time has not yet expired. Some embodiments may reclaim resources if the required invitee has not joined any conference after a predetermined amount of time. Other methods for reclaiming resources may be used in other embodiments.

Some of the steps illustrated in FIG. 3 may be combined, modified or deleted where appropriate, and additional steps may also be added to the flowchart. Additionally, steps may be performed in any suitable order without departing from the scope of the invention.

Although the present invention has been described in detail with reference to particular embodiments, it should be understood that various other changes, substitutions, and alterations may be made hereto without departing from the spirit and scope of the present invention. For example, although the present invention has been described with reference to a number of elements included within a conferencing system 60, these elements may be combined, rearranged or positioned in order to accommodate particular routing architectures or needs. In addition, any of these elements may be provided as separate external components to conferencing system 60, or each other where appropriate. The present invention contemplates great flexibility in the arrangement of these elements as well as their internal components.

Numerous other changes, substitutions, variations, alterations and modifications may be ascertained by those skilled in the art and it is intended that the present invention encompass all such changes, substitutions, variations, alterations and modifications as falling within the spirit and scope of the appended claims.

What is claimed is:

1. A method for reserving resources in a conferencing system, comprising:
receiving a conference reservation request for a first conference comprising at least one invitee; and
reserving for the at least one invitee a conference resource to allow the at least one invitee to participate in the first conference using the conference resource, the conference resource usable by the at least one invitee to participate in one or more additional conferences occurring simultaneously with the first conference.

2. The method of claim 1, further comprising:
sending a conference invitation for the first conference to the at least one invitee; and
receiving from the at least one invitee an invitation response indicating an intention to participate in the first conference.

3. The method of claim 1, further comprising:
connecting the at least one invitee to the first conference using the reserved conference resource to enable the at least one invitee to participate in the first conference;
receiving a request from the at least one invitee to participate in a second conference of the one or more additional conferences;
transferring the at least one invitee from the first conference to the second conference using the reserved conference resource to enable the at least one invitee to participate in the second conference.

4. The method of claim 3, wherein the conference resource comprises a conference port.

5. The method of claim 3, wherein the conference resource comprises a digital signal processing (DSP) resource.

6. The method of claim 3, wherein the second conference comprises a conference to which the at least one invitee did not receive an electronic conference invitation.

7. The method of claim 1, further comprising:
receiving from the at least one invitee a reservation request indicating an intention to participate in a second conference occurring simultaneously with the first conference; and
in response to receiving the indication from the at least one invitee, reserving for the at least one invitee a second conference resource to allow the at least one invitee to participate in the second conference using the second conference resource while the at least one invitee participates in the first conference using the first conference resource.

8. A method for reserving resources in a conference system, comprising:
reserving for a participant, for a participatory amount of time, a conference resource usable by the participant to participate in any one of a plurality conferences;
connecting the participant to a first conference of the plurality of conferences using the reserved conference resource to enable the participant to participate in the first conference;
receiving within the participatory amount of time a request from the participant to participate in a second conference of the plurality of conferences;
transferring the participant from the first conference to the second conference using the reserved conference resource to enable the participant to participate in the second conference.

9. The method of claim 8, wherein the conference resource comprises a conference port.

10. The method of claim 8, wherein the conference resource comprises a digital signal processing (DSP) resource.

11. A system for reserving resources in a conferencing system, comprising:
an interface operable to receive a conference reservation request for a first conference comprising at least one invitee; and
a processor coupled to the interface and operable to reserve for the at least one invitee a conference resource to allow the at least one invitee to participate in the first conference using the conference resource, the conference resource usable by the at least one invitee to participate in one or more additional conferences occurring simultaneously with the first conference.

12. The system of claim 11, wherein the interface is further operable to:
send a conference invitation for the first conference to the at least one invitee; and
receive from the at least one invitee an invitation response indicating an intention to participate in the first conference.

13. The system of claim 11, wherein:
the processor is further operable to connect the at least one invitee to the first conference using the reserved conference resource to enable the at least one invitee to participate in the first conference;
the interface is further operable to receive a request from the at least one invitee to participate in a second conference of the one or more additional conferences; and
the processor is further operable to transfer the at least one invitee from the first conference to the second conference using the reserved conference resource to enable the at least one invitee to participate in the second conference.

14. The system of claim 13, wherein the conference resource comprises a conference port.

15. The system of claim 13, wherein the conference resource comprises a digital signal processing (DSP) resource.

16. The system of claim 13, wherein the second conference comprises a conference to which the at least one invitee did not receive an electronic conference invitation.

17. The system of claim 11, wherein:
the interface is further operable to receive from the at least one invitee a reservation request indicating an intention to participate in a second conference occurring simultaneously with the first conference; and
the processor, in response to receiving the indication from the at least one invitee, is further operable to reserve for the at least one invitee a second conference resource to allow the at least one invitee to participate in the second conference using the second conference resource while the at least one invitee participates in the first conference using the first conference resource.

18. A system for reserving resources in a conference system, comprising:
a processor operable to:
reserve for a participant, for a participatory amount of time, a conference resource usable by the participant to participate in any one of a plurality conferences; and
connect the participant to a first conference of the plurality of conferences using the reserved conference resource to enable the participant to participate in the first conference;
an interface coupled to the processor and operable to receive within the participatory amount of time a request from the participant to participate in a second conference of the plurality of conferences; and
wherein the processor is further operable to transfer the participant from the first conference to the second conference using the reserved conference resource to enable the participant to participate in the second conference.

19. The system of claim 18, wherein the conference resource comprises a conference port.

20. The system of claim 18, wherein the conference resource comprises a digital signal processing (DSP) resource.

21. Logic embodied in a computer readable medium, the computer readable medium comprising code operable to:
receive a conference reservation request for a first conference comprising at least one invitee; and
reserve for the at least one invitee a conference resource to allow the at least one invitee to participate in the first conference using the conference resource, the conference resource usable by the at least one invitee to participate in one or more additional conferences occurring simultaneously with the first conference.

22. The medium of claim 21, wherein the code is further operable to:
send a conference invitation for the first conference to the at least one invitee; and
receive from the at least one invitee an invitation response indicating an intention to participate in the first conference.

23. The medium of claim 21, wherein the code is further operable to:
connect the at least one invitee to the first conference using the reserved conference resource to enable the at least one invitee to participate in the first conference;
receive a request from the at least one invitee to participate in a second conference of the one or more additional conferences;
transfer the at least one invitee from the first conference to the second conference using the reserved conference resource to enable the at least one invitee to participate in the second conference.

24. The medium of claim 23, wherein the conference resource comprises a conference port.

25. The medium of claim 23, wherein the conference resource comprises a digital signal processing (DSP) resource.

26. The medium of claim 23, wherein the second conference comprises a conference to which the at least one invitee did not receive an electronic conference invitation.

27. The medium of claim 21, wherein the code is further operable to:
receive from the at least one invitee a reservation request indicating an intention to participate in a second conference occurring simultaneously with the first conference; and
in response to receiving the indication from the at least one invitee, reserve for the at least one invitee a second conference resource to allow the at least one invitee to participate in the second conference using the second conference resource while the at least one invitee participates in the first conference using the first conference resource.

28. Logic embodied in a computer readable medium, the computer readable medium comprising code operable to:
reserve for a participant, for a participatory amount of time, a conference resource usable by the participant to participate in any one of a plurality of conferences;
connect the participant to a first conference of the plurality of conferences using the reserved conference resource to enable the participant to participate in the first conference;
receive within the participatory amount of time a request from the participant to participate in a second conference of the plurality of conferences;
transfer the participant from the first conference to the second conference using the reserved conference resource to enable the participant to participate in the second conference.

29. The medium of claim 28, wherein the conference resource comprises a conference port.

30. The medium of claim 28, wherein the conference resource comprises a digital signal processing (DSP) resource.

31. A system for reserving resources in a conferencing system, comprising:
means for receiving a conference reservation request for a first conference comprising at least one invitee; and
means for reserving for the at least one invitee a conference resource to allow the at least one invitee to participate in the first conference using the conference resource, the conference resource usable by the at least one invitee to participate in one or more additional conferences occurring simultaneously with the first conference.
